(19) United States
(12) Patent Application Publication
(10) Pub. No.: US 2008/0289186 A1
(43) Pub. Date: Nov. 27, 2008

(54) Scissor shear apparatus for shearing material

(76) Inventor: Allan R. Adams, Stoughton, WI (US)

Correspondence Address: DAVID J. ARCHER, 7037 POMERY ROAD, ROCKTON, IL, 61072, US

(21) Appl. No.: 12/152,646

(22) Filed: May 15, 2008

Related U.S. Application Data
(60) Provisional application No. 60/930,291, filed on May 15, 2007.

(51) Int. Cl. B23D 21/00; B26B 13/28

(52) U.S. Cl. 30/92; 30/244

(57) ABSTRACT

A scissor shear apparatus is disclosed for shearing material. The apparatus includes a frame and a first shear blade having a first and a second end, the first shear blade being pivotally secured to the frame about a first pivotal axis which extends through the frame and through the first shear blade between the ends thereof. The first shear blade defines a first cutting edge which is disposed adjacent to the first end thereof. A second shear blade has a first and a second extremity, the second shear blade being pivotally secured to the frame about the first pivotal axis between the extremities thereof. The second shear blade defines a second cutting edge which is disposed adjacent to the first extremity thereof such that the cutting edges cooperate together for shearing the material when the second end of the first shear blade and the second extremity of the second shear blade move away from each other for pivoting the shear blades relative to each other. A first link has a first and a second end, the first end of the first link being pivotally secured to the second end of the first shear blade for rotation thereof about a second pivotal axis which is disposed parallel and spaced relative to the first pivotal axis. A second link has a first and a second extremity, the first extremity of the second link being pivotally secured to the second extremity of the second shear blade for rotation thereof about a third pivotal axis which is disposed parallel and spaced relative to the first and second pivotal axes. An axle is disposed adjacent to the second end of the first link and the second extremity of the second link such that the axle and second end and extremity respectively of the links pivot about a fourth axis which is disposed spaced and parallel relative to the first, second and third axes. A first arm has a first and a second end, the first arm being secured to the frame about a fifth pivotal axis which is disposed spaced and parallel relative to the first, second, third and fourth axes. The fifth axis is disposed between the ends of the first arm. The first end of the first arm defines a lost motion linkage which is connected to the axle such that when the first arm pivots about the fifth axis, the axle is moved by the lost motion linkage for moving the second end of the first shear blade and the second extremity of the second shear blade towards and away from each other for pivoting the shear blades relative to each other. A second arm has a first and a second extremity, the first extremity of the second arm being pivotally secured to the second end of the first arm for pivotally driving the first arm. A crank is rotatably secured to the flame about a first rotational axis. The crank includes a crank pin which has a second rotational axis which is disposed spaced and parallel relative to the first rotational axis such that, when the crank rotates about the first rotational axis, the second rotational axis of the crank pin orbits about the first rotational axis. The crank pin is pivotally secured to the second extremity of the second arm such that, when the crank is rotated about the first rotational axis, the second arm is reciprocated for pivoting the first arm about the fifth pivotal axis so that the cutting edges of the blades shear the material.

### CROSS REFERENCE TO RELATED PATENT APPLICATION

The present application is a Complete application filed pursuant to Provisional patent application U.S. Ser. No. 60/930,291 filed May 15, 2007. All of the disclosure of U.S. Ser. No. 60/930,291 is incorporated herein by reference.

### FIELD OF THE INVENTION

1. Background of the Invention

The present invention relates to a scissor shear apparatus.

More specifically, the present invention relates to a heavy duty scissor shear apparatus for shearing material.

2. Background Information

Heavy duty shears are used for cutting steel rod and the like. Typical shears include scissor type cutting blades which pivot about a common pivot or spaced pivots so that when a force is applied to the arms remote from the cutting edges, sufficient leverage is applied for shearing through the material to be cut.

However, when large steel rods are to be sheared, the leverage required to cut such rods is considerable. The present invention provides a unique means for generating sufficient leverage to easily cut through such rods.

Therefore, the primary feature of the present invention is the provision of a scissor shear apparatus for shearing material that overcomes the problems associated with the prior art scissor shear arrangements and which makes a significant contribution to the scissor shear art.

Another feature of the present invention is the provision of scissor shear that increases the leverage applied to the cutting blades of the scissor shear apparatus.

Other features and advantages of the present invention will be readily apparent to those skilled in the art by a consideration of the detailed description of a preferred embodiment of the present invention contained herein.

### SUMMARY OF THE INVENTION

The present invention relates to a scissor shear apparatus for shearing material. The apparatus includes a flame and a first shear blade having a first and a second end. The first shear blade is pivotally secured to the flame about a first pivotal axis which extends through the frame and through the first shear blade between the ends thereof. The first shear blade defines a first cutting edge which is disposed adjacent to the first end thereof.

A second shear blade has a first and a second extremity, the second shear blade being pivotally secured to the frame about the first pivotal axis between the extremities thereof. The second shear blade defines a second cutting edge which is disposed adjacent to the first extremity thereof such that the cutting edges cooperate together for shearing the material when the second end of the first shear blade and the second extremity of the second shear blade move away from each other for pivoting the shear blades relative to each other.

A first link has a first and a second end, the first end of the first link being pivotally secured to the second end of the first shear blade for rotation thereof about a second pivotal axis. The second pivotal axis is disposed parallel and spaced relative to the first pivotal axis. A second link has a first and a second extremity, the first extremity of the second link being pivotally secured to the second extremity of the second shear blade for rotation thereof about a third pivotal axis which is disposed parallel and spaced relative to the first and second pivotal axes.

An axle is disposed adjacent to the second end of the first link and the second extremity of the second link. The arrangement is such that the axle and second end and extremity respectively of the links pivot about a fourth axis which is disposed spaced and parallel relative to the first, second and third axes.

A first arm has a first and a second end, the first arm being secured to the frame about a fifth pivotal axis which is disposed spaced and parallel relative to the first, second, third and fourth axes. The fifth axis is disposed between the ends of the first arm. The first end of the first arm defines a lost motion linkage which is connected to the axle such that when the first arm pivots about the fifth pivotal axis, the axle is moved by the lost motion linkage for moving the second end of the first shear blade and the second extremity of the second shear blade towards and away from each other for pivoting the shear blades relative to each other.

A second arm has a first and a second extremity, the first extremity of the second arm being pivotally secured to the second end of the first arm for pivotally driving the first arm. A crank is rotatably secured to the frame about a first rotational axis. The crank includes a crank pin which has a second rotational axis which is disposed spaced and parallel relative to the first rotational axis such that when the crank rotates about the first rotational axis, the second rotational axis of the crank pin orbits about the first rotational axis. The crank pin is pivotally secured to the second extremity of the second arm such that, when the crank is rotated about the first rotational axis, the second arm is reciprocated for pivoting the first arm about the fifth pivotal axis so that the cutting edges of the blades shear the material.

In a more specific embodiment of the present invention, the frame includes a first plate which has a first and a second end and a top and a bottom edge. A second plate is disposed spaced and parallel relative to the first plate, the second plate having a first and a second end and a top and a bottom edge.

Moreover, the first pivotal axis extends normally through the plates, the blades being disposed between the plates.

Also, the links and the axle are disposed between the plates, the fourth pivotal axis being disposed normal to the plates such that the fourth pivotal axis moves relative to the first pivotal axis.

Additionally, the lost motion linkage includes an elongate slot defined by the first end of the first arm for the slidable reception therein of the axle such that, when the first arm pivots about the fifth pivotal axis, the slot cooperates with the axle for urging the axle to move relative to the first pivotal axis.

Furthermore, the plates define a first and a second guide such that the axle extends through and is guided by the guides so that when the lost motion linkage cooperates with the axle, the axle is urged along and is guided by the guides.

Also, the guides and the first pivotal axis are coplanar and the first and second rotational axes are disposed spaced and parallel relative to the first pivotal axis.

More particularly, the first and fifth pivotal axes and the first rotational axis are fixed relative to the frame while the second, third and fourth pivotal axes and the second rotational axis are movable relative to the flame.

A motor is drivingly connected to the crank for rotating the crank about the first axis of rotation.

Many modifications and variations of the present invention will be readily apparent to those skilled in the art by a consideration of the detailed description contained hereinafter taken in conjunction with the annexed drawings which show a preferred embodiment of the present invention. However, such modifications and variations fall within the spirit and scope of the present invention as defined by the appended claims.

### BRIEF DESCRIPTION OF THE DRAWINGS

FIG. 1 is a side elevational view, partially in section, of a scissor shear apparatus according to the present invention for shearing material;

FIG. 2 is a top plan view of the apparatus shown in FIG. 1; and

FIG. 3 is a view taken on the line 3-3 of FIG. 2.

Similar reference characters refer to similar parts throughout the various views of the drawings.

### DETAILED DESCRIPTION OF THE DRAWINGS

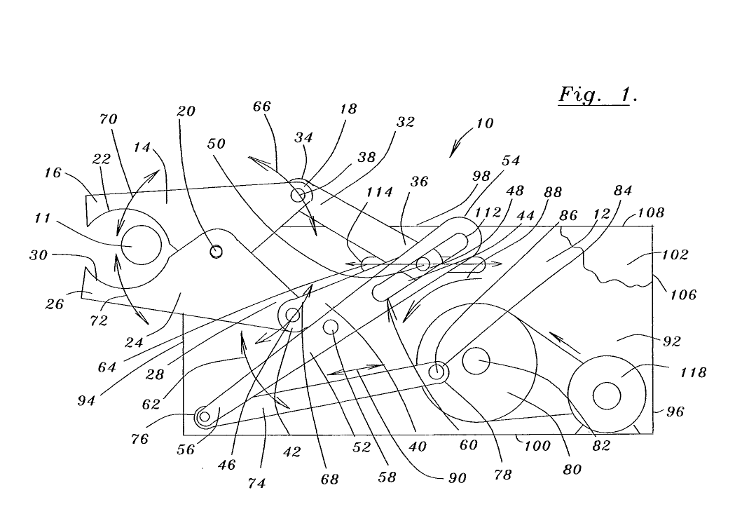

FIG. 1 is a side elevational view, partially in section, of a scissor shear apparatus generally designated 10 according to the present invention for shearing material 11. As shown in FIG. 1, the apparatus 10 includes a frame 12 and a first shear blade 14 having a first and a second end 16 and 18 respectively. The first shear blade 14 is pivotally secured to the frame 12 about a first pivotal axis 20 which extends through the frame 12 and through the first shear blade 14 between the ends 16 and 18 thereof. The first shear blade 14 defines a first cutting edge 22 which is disposed adjacent to the first end 16 thereof. A second shear blade 24 has a first and a second extremity 26 and 28 respectively. The second shear blade 24 is pivotally secured to the frame 12 about the first pivotal axis 20 between the extremities 26 and 28 thereof. The second shear blade 24 defines a second cutting edge 30 which is disposed adjacent to the first extremity 26 thereof such that the cutting edges 22 and 30 cooperate together for shearing the material 11, such as a steel rod when the second end 18 of the first shear blade 14 and the second extremity 28 of the second shear blade 24 move away from each other for pivoting the shear blades 14 and 24 relative to each other about the first pivotal axis 20.

A first link 32 has a first and a second end 34 and 36 respectively, the first end 34 of the first link 32 being pivotally secured to the second end 18 of the first shear blade 14 for rotation thereof about a second pivotal axis 38 which is disposed parallel and spaced relative to the first pivotal axis 20.

A second link 40 has a first and a second extremity 42 and 44 respectively. The first extremity 42 of the second link 40 is pivotally secured to the second extremity 28 of the second shear blade 24 for rotation thereof about a third pivotal axis 46 which is disposed parallel and spaced relative to the first and second pivotal axes 20 and 38 respectively.

An axle 48 is disposed adjacent to the second end 36 of the first link 32 and the second extremity 44 of the second link 40. The arrangement is such that the axle 48 and second end 36 and second extremity 44 respectively of the links 32 and 40 pivot about a fourth pivotal axis 50 which is disposed spaced and parallel relative to the first, second and third pivotal axes 20, 38 and 46 respectively.

A first arm 52 has a first and a second end 54 and 56, the first arm 52 being secured to the frame 12 about a fifth pivotal axis 58 disposed spaced and parallel relative to the first, second, third and fourth pivotal axes 20,38,46 and 50 respectively. The fifth pivotal axis 58 is disposed between the ends 54 and 56 of the first arm 52. The first end 54 of the first arm 52 defines a lost motion linkage generally designated 60 which cooperates with the axle 48 such that, when the first arm 52 pivots about the fifth pivotal axis 58, as indicated by the arrow 62, the axle 48 is moved by the lost motion linkage 60 as indicated by the arrow 64 for moving the second end 18 of the first shear blade 14 and the second extremity 28 of the second shear blade 24 towards and away from each other as indicated by the arrows 66 and 68 respectively for pivoting the shear blades 14 and 24 relative to each other as indicated by the arrows 70 and 72 respectively.

A second arm 74 has a first and a second extremity 76 and 78 respectively. The first extremity 76 of the second arm 74 is pivotally secured to the second end 56 of the first arm 52 for pivotally driving the first arm 52.

A crank 80 is rotatably secured to the frame 12 about a first rotational axis 82. The crank 80 includes a crank pin 84 which rotates about a second rotational axis 86 disposed spaced and parallel relative to the first rotational axis 82. The arrangement is such that, when the crank 80 rotates about the first rotational axis 82, as indicated by the arrow 88, the second rotational axis 86 of the crank pin 84 orbits about the first rotational axis 82. The crank pin 84 is pivotally secured to the second extremity 78 of the second arm 74 such that, when the crank 80 is rotated, as indicated by the arrow 88, about the first rotational axis 82, the second arm 74 is reciprocated, as indicated by the arrow 90. Such reciprocation 90 of the arm 74 pivots the first arm 52 as indicated by the arrow 62. The arrangement is such that the pivoting of the first arm 52 about the fifth pivotal axis 58 causes the cutting edges 22 and 30 of the blades 14 and 24 to shear the material 11.

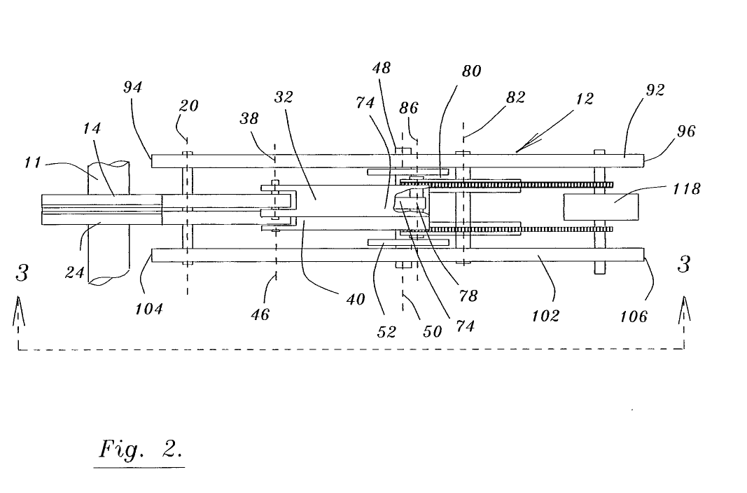

FIG. 2 is a top plan view of the apparatus shown in FIG. 1. As shown in FIG. 2, the frame 12 includes a first plate 92 which has a first and a second end 94 and 96.

As shown in FIG. 1, the first plate 92b has a top and a bottom edge 98 and 100.

As shown in FIG. 2, a second plate 102 is disposed spaced and parallel relative to the first plate 92, the second plate 102 having a first and a second end 104 and 106.

As shown in FIG. 1, the second plate 102 has a top edge 108.

As shown in FIG. 2, the first pivotal axis 20 extends normally through the plates 92 and 102, the blades 14 and 24 being disposed between the plates 92 and 102.

Also, the links 32 and 40 and the axle 48 are disposed between the plates 92 and 102. The fourth pivotal axis 50 is disposed normal to the plates 92 and 102 such that the fourth pivotal axis 50 moves relative to the first pivotal axis 20.

Additionally, as shown in FIG. 1, the lost motion linkage 60 includes an elongate slot 112 defined by the first end 54 of the first arm 52 for the slidable reception therein of the axle 48. The arrangement is such that, when the first arm 52 pivots about the fifth pivotal axis 58, the slot 112 cooperates with the axle 48 for urging the axle 48 to move as indicated by the arrow 64 relative to the first pivotal axis 20.

Furthermore, the plate 92 defines a first guide 114 such that the axle 48 extends through and is guided by the first guide 114 so that when the lost motion linkage 60 cooperates with the axle 48, the axle 48 is urged along and is guided by the first guide 114.

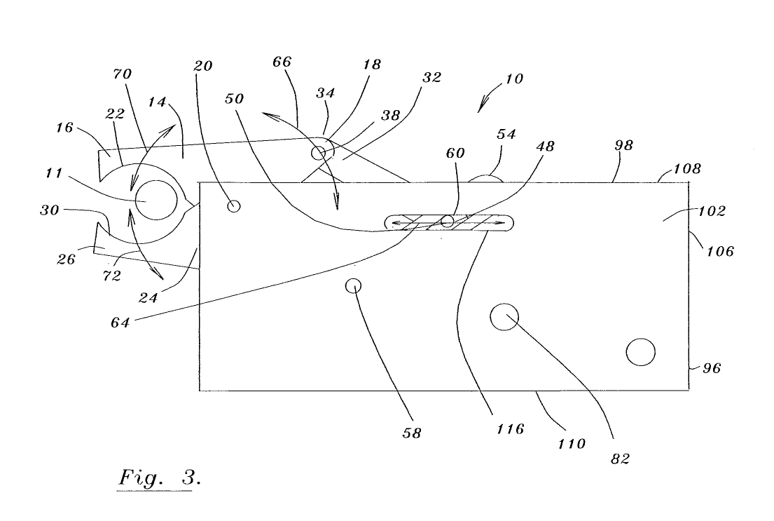

FIG. 3 is a view taken on the line 3-3 of FIG. 2. As shown in FIG. 3, the second plate 102 defines a second guide 116 such that the axle 48 extends through and is guided by the second guide 116 so that, when the lost motion linkage 60 cooperates with the axle 48, the axle 48 is urged along and is guided by the second guide 116. Also, the second plate 102 has a bottom edge 110.

Also, the guides 114 and 116 and the first pivotal axis 20 are coplanar.

As shown in FIG. 2, the first and second rotational axes 82 and 86 are disposed spaced and parallel relative to the first pivotal axis 20.

As shown in FIG. 1, the first and fifth pivotal axes 20 and 58 and the first rotational axis 82 are fixed relative to the frame 12 while the second, third and fourth pivotal axes 38, 46 and 50 and the second rotational axis 86 are movable relative to the frame 12.

A motor 118 is drivingly connected to the crank 80 for rotating the crank about the first rotational axis 82 as indicated by the arrow 88.

In operation of the apparatus 10, the material 11 is positioned between the opposing cutting edges 22 and 30 and the motor 118, such as an electric motor is energized. The motor 118 rotates the crank 80 which reciprocates the second arm 74. The second arm 74 is moved to the right as shown in FIG. 1 so that the first arm 52 is pivoted about the fifth pivotal axis 58. The elongate slot 112 pushes the axle 48 to the left. The axle 48 is guided by guides 114 and 116 so that the second and third pivotal axes 38 and 46 of the links 32 and 40 move away from each other thereby exerting considerable leverage on the first and second shear blades 14 and 24 for shearing the material 11.

The present invention provides a unique scissor shear arrangement for exerting considerable leverage on scissor type shear blades for cutting material.

What is claimed is:

1. A scissor shear apparatus for shearing material, said apparatus comprising:
a frame;
a first shear blade having a first and a second end, said first shear blade being pivotally secured to said frame about a first pivotal axis which extends through said frame and through said first shear blade between said ends thereof, said first shear blade defining a first cutting edge disposed adjacent to said first end thereof;
a second shear blade having a first and a second extremity, said second shear blade being pivotally secured to said frame about said first pivotal axis between said extremities thereof, said second shear blade defining a second cutting edge disposed adjacent to said first extremity thereof such that said cutting edges cooperate together for shearing the material when said second end of said first shear blade and said second extremity of said second shear blade move away from each other for pivoting said shear blades relative to each other;
a first link having a first and a second end, said first end of said first link being pivotally secured to said second end of said first shear blade for rotation thereof about a second pivotal axis which is disposed parallel and spaced relative to said first pivotal axis;
a second link having a first and a second extremity, said first extremity of said second link being pivotally secured to said second extremity of said second shear blade for rotation thereof about a third pivotal axis which is disposed parallel and spaced relative to said first and second pivotal axes;
an axle disposed adjacent to said second end of said first link and said second extremity of said second link such that said axle and second end and extremity respectively of said links pivot about a fourth pivotal axis which is disposed spaced and parallel relative to said first, second and third pivotal axes;
a first arm having a first and a second end, said first arm being secured to said frame about a fifth pivotal axis disposed spaced and parallel relative to said first, second, third and fourth pivotal axes, said fifth pivotal axis being disposed between said ends of said first arm, said first end of said first arm defining a lost motion linkage which is connected to said axle such that, when said first arm pivots about said fifth axis, said axle is moved by said lost motion linkage for moving said second end of said first shear blade and said second extremity of said second shear blade towards and away from each other for pivoting said shear blades relative to each other;
a second arm having a first and a second extremity, said first extremity of said second arm being pivotally secured to said second end of said first arm for pivotally driving said first arm;
a crank rotatably secured to said frame about a first rotational axis; and
said crank including:
a crank pin having a second rotational axis which is disposed spaced and parallel relative to said first rotational axis such that when said crank rotates about said first rotational axis, said second rotational axis of said crank pin orbits about said first rotational axis, said crank pin being pivotally secured to said second extremity of said second arm such that, when said crank is rotated about said first rotational axis, said second arm is reciprocated for pivoting said first arm about said fifth pivotal axis so that said cutting edges of said blades shear the material.

2. A scissor shear apparatus as set forth in claim 1 wherein
said flame includes:
a first plate having a first and a second end and a top and a bottom edge;
a second plate disposed spaced and parallel relative to said first plate, said second plate having a first and a second end and a top and a bottom edge.

3. A scissor shear apparatus as set forth in claim 2 wherein
said first pivotal axis extends normally through said plates, said blades being disposed between said plates.

4. A scissor shear apparatus as set forth in claim 3 wherein
said links are disposed between said plates.

5. A scissor shear apparatus as set forth in claim 2 wherein
said axle is disposed between said blades, said fourth pivotal axis being disposed normal to said plates such that said fourth pivotal axis moves relative to said first pivotal axis.

6. A scissor shear apparatus as set forth in claim 1 wherein
said lost motion linkage includes:
an elongate slot defined by said first end of said first arm for the slidable reception therein of said axle such that, when said first arm pivots about said fifth pivotal axis, said slot cooperates with said axle for urging said axle to move relative to said pivotal axis.

7. A scissor shear apparatus as set forth in claim 2 wherein
said plates define a first and a second guide respectively such that said axle extends through and is guided by said guides so that when said lost motion linkage cooperates with said axle, said axle is urged along and is guided by said guides.

8. A scissor shear apparatus as set forth in claim 7 wherein
said guides and said first pivotal axis are coplanar.

9. A scissor shear apparatus as set forth in claim 1 wherein
said first and second rotational axes are disposed spaced and parallel relative to said first pivotal axis.

10. A scissor shear apparatus as set forth in claim 1 wherein
said first and fifth pivotal axes and said first rotational axis are fixed relative to said frame;
said second, third and fourth pivotal axes and said second rotational axis are movable relative to said frame.

11. A scissor shear apparatus as set forth in claim 1 further including:
a motor drivingly connected to said crank for rotating said crank about said first rotational axis.

12. A scissor shear apparatus for shearing material, said apparatus comprising:
a flame;
a first shear blade having a first and a second end, said first shear blade being pivotally secured to said frame about a first pivotal axis which extends through said flame and said first shear blade between said ends thereof, said first shear blade defining a first cutting edge disposed adjacent to said first end thereof;
a second shear blade having a first and a second extremity, said second shear blade being pivotally secured to said flame about said first pivotal axis between said extremities thereof, said second shear blade defining a second cutting edge disposed adjacent to said first extremity thereof such that said cutting edges cooperate together for shearing the material when said second end of said first shear blade and said second extremity of said second shear blade move away from each other for pivoting said shear blades relative to each other;
a first link having a first and a second end, said first end of said first link being pivotally secured to said second end of said first shear blade for rotation thereof about a second pivotal axis which is disposed parallel and spaced relative to said first pivotal axis;
a second link having a first and a second extremity, said first extremity of said second link being pivotally secured to said second extremity of said second shear blade for rotation thereof about a third pivotal axis which is disposed parallel and spaced relative to said first and second pivotal axes;
an axle disposed adjacent to said second end of said first link and said second extremity of said second link such that said axle and second end and extremity respectively of said links pivot about a fourth axis which is disposed spaced and parallel relative to said first, second and third axes;
a first arm having a first and a second end, said first arm being secured to said frame about a fifth pivotal axis disposed spaced and parallel relative to said first, second, third and fourth axes, said fifth axis being disposed between said ends of said first arm, said first end of said first arm defining a lost motion linkage connected to said axle such that when said first arm pivots about said fifth axis, said axle is moved by said lost motion linkage for moving said second end of said first shear blade and said second extremity of said second shear blade towards and away from each other for pivoting said shear blades relative to each other;
a second arm having a first and a second extremity, said first extremity of said second arm being pivotally secured to said second end of said first arm for pivotally driving said first arm;
a crank rotatably secured to said frame about a first rotational axis;
said crank including:
a crank pin having a second rotational axis which is disposed spaced and parallel relative to said first rotational axis such that when said crank rotates about said first rotational axis said second rotational axis of said crank pin orbits about said first rotational axis, said crank pin being pivotally secured to said second extremity of said second arm such that, when said crank is rotated about said first rotational axis, said second arm is reciprocated for pivoting said first arm about said fifth pivotal axis so that said cutting edges of said blades shear the material; and
said lost motion linkage includes:
an elongate slot defined by said first end of said first arm for the slidable reception therein of said axle such that, when said first arm pivots about said fifth pivotal axis, said slot cooperates with said axle for urging said axle to move relative to said first pivotal axis.

13. A scissor shear apparatus for shearing material, said apparatus comprising:
a frame;
a first shear blade having a first and a second end, said first shear blade being pivotally secured to said frame about a first pivotal axis which extends through said frame and said first shear blade between said ends thereof, said first shear blade defining a first cutting edge disposed adjacent to said first end thereof,
a second shear blade having a first and a second extremity, said second shear blade being pivotally secured to said frame about said first pivotal axis between said extremities thereof, said second shear blade defining a second cutting edge disposed adjacent to said first extremity thereof such that said cutting edges cooperate together for shearing the material when said second end of said first shear blade and said second extremity of said second shear blade move away from each other for pivoting said shear blades relative to each other;
a first link having a first and a second end, said first end of said first link being pivotally secured to said second end of said first shear blade for rotation thereof about a second pivotal axis which is disposed parallel and spaced relative to said first pivotal axis;
a second link having a first and a second extremity, said first extremity of said second link being pivotally secured to said second extremity of said second shear blade for rotation thereof about a third pivotal axis which is disposed parallel and spaced relative to said first and second pivotal axes;
an axle disposed adjacent to said second end of said first link and said second extremity of said second link such that said axle and second end and extremity respectively of said links pivot about a fourth axis which is disposed spaced and parallel relative to said first, second and third axes;
a first arm having a first and a second end, said first arm being secured to said frame about a fifth pivotal axis disposed spaced and parallel relative to said first, second, third and fourth axes, said fifth axis being disposed between said ends of said first arm, said first end of said first arm defining a lost motion linkage connected to said axle such that when said first arm pivots about said fifth axis, said axle is moved by said lost motion linkage for moving said second end of said first shear blade and said second extremity of said second shear blade towards and away from each other for pivoting said shear blades relative to each other;
a second arm having a first and a second extremity, said first extremity of said second arm being pivotally secured to said second end of said first arm for pivotally driving said first arm;
a crank rotatably secured to said frame about a first rotational axis;
said crank including:
a crank pin having a second rotational axis which is disposed spaced and parallel relative to said first rotational axis such that when said crank rotates about said first rotational axis said second rotational axis of said crank pin orbits about said first rotational axis, said crank pin being pivotally secured to said second extremity of said second arm such that, when said crank is rotated about said first rotational axis, said second arm is reciprocated for pivoting said first arm about said fifth pivotal axis so that said cutting edges of said blades shear the material;
said flame including:
a first plate having a first and a second end and a top and a bottom edge;
a second plate disposed spaced and parallel relative to said first plate, said second plate having a first and a second end and a top and a bottom edge;
said first pivotal axis extends normally through said plates, said blades being disposed between said plates;
said links are disposed between said plates;
said axle is disposed between said blades, said fourth pivotal axis being disposed normal to said plates such that said fourth pivotal axis moves relative to said first pivotal axis;
said lost motion linkage including:
an elongate slot defined by said first end of said first arm for the slidable reception therein of said axle such that, when said first arm pivots about said fifth pivotal axis, said slot cooperates with said axle for urging said axle to move relative to said pivotal axis;
said plates define a first and a second guide respectively such that said axle extends through and is guided by said guides so that when said lost motion linkage cooperates with said axle, said axle is urged along and is guided by said guides;
said guides and said first pivotal axis are coplanar;
said first and second rotational axes are disposed spaced and parallel relative to said first pivotal axis;
said first and fifth pivotal axes and said first rotational axis are fixed relative to said flame;
said second, third and fourth pivotal axes and said second rotational axis are movable relative to said flame; and
a motor drivingly connected to said crank for rotating said crank about said first axis of rotation.
